(19) United States
(12) Patent Application Publication
(10) Pub. No.: US 2005/0246747 A1
(43) Pub. Date: Nov. 3, 2005

(54) Utilization of data broadcasting technology with handheld control apparatus

(75) Inventors: David Alan Braun, Denville, NJ (US); Yue Ma, West Windsor, NJ (US); Chie-Chung Chang, Monmouth Jct., NJ (US); Rajesh Bhagwandas Khandelwal, Bridgewater, NJ (US); Alan Kaplan, Princeton, NJ (US); Eran Sitnik, Ossining, NY (US)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Kadoma-Shi, Osaka (JP)

(21) Appl. No.: 10/510,171

(22) PCT Filed: Mar. 31, 2003
(86) PCT No.: PCT/US03/09874

§ 371 Date: Oct. 4, 2004

(51) Int. Cl. H04N 5/44

(52) U.S. Cl. 725/81; 348/734

(57) ABSTRACT

A television entertainment system has two-way communication capability with a hand-held remote device accessing an external information source. It includes a television receiver adapted to receive television programming content, and a television set top box adapted to receive program related information over a broadcast channel and transmit the program related information to the hand-held remote device. The hand-held remote device is adapted to visually render information received over a broadcast channel and synchronize delivery of the program related information with delivery of related information from the external information source.

### FIELD OF THE INVENTION

The present invention relates to the practice of placing supplementary data within a television broadcast signal, such as within the vertical blanking interval (VBI) of analog television broadcasts or transport stream of digital broadcasts. More specifically, the present invention discloses a method for utilizing the supplementary data to communicate digital information and providing an interactive interface to a user.

### BACKGROUND AND SUMMARY OF THE INVENTION

The present invention implements a handheld control device to optimize a user's view of data communicated within a television broadcast signal, such as within the VBI in analog broadcast or transport stream in digital broadcast. Broadcasters place supplementary information (also referred to as digital data or meta data) within a broadcast signal. Examples of supplementary information include triggers, electronic program guides (EPG), interactive games associated with an ongoing program, and others. The supplementary information is usually transmitted in sync with TV programs, resulting in limited available bandwidth; therefore, only a limited amount of data can be communicated.

As a consequence of the limited bandwidth available within TV broadcasting, communication of data to a user is often slow and inefficient. Even higher bandwidth can be achieved in digital broadcast, but the drawback still exists, as in analog, that once supplementary information is authorized at the head end, contents can not be easily altered. There is a need to send more up-to-date information (such as EPG, weather etc.) to the user. The present invention overcomes the inherent limitations that are associated with embedding data in both analog and digital broadcasting. In a preferred embodiment, the aforementioned handheld control device contains a metadata manager that cooperates with the data decoder and parser to receive data embedded in a broadcasting signal. By using applications operating within the handheld control device, a user can utilize metadata more efficiently and take advantage of faster, optimized information access. The utilization of data includes, but is not limited to: the use of data to trigger applications on the handheld device; data synchronization with an external source, such as a data card or the Internet, to trigger other applications on the handheld device; and the ability to search data content, such as electronic program guides, via user inputs, including, but not limited to, handwriting input, a keyboard, or a user interface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is one embodiment of the handheld control device of the present invention.

FIG. 2 is one embodiment of the system architecture of the present invention.

FIG. 3 describes an integrated closed caption device that is able to extract all VBI data in analog broadcasting and present it to an external device through a general purpose data port.

FIG. 4 describes an integrated data formatter that is able to reformat data from the general purpose data port to be compatible with various media interfaces.

FIG. 5 describes a set-top box that is able to process both data from an integrated VBI decoder and enhanced closed caption data from an external source via a general purpose data port.

FIG. 6 is a block diagram illustrating the detailed operation of the handheld device and the set-top box of FIG. 2 according to a second embodiment of the current invention.

### DETAILED DESCRIPTION OF THE PREFERRED EMBODIMENTS

The following description of the preferred embodiments is merely exemplary in nature and is in no way intended to limit the invention, its application, or uses.

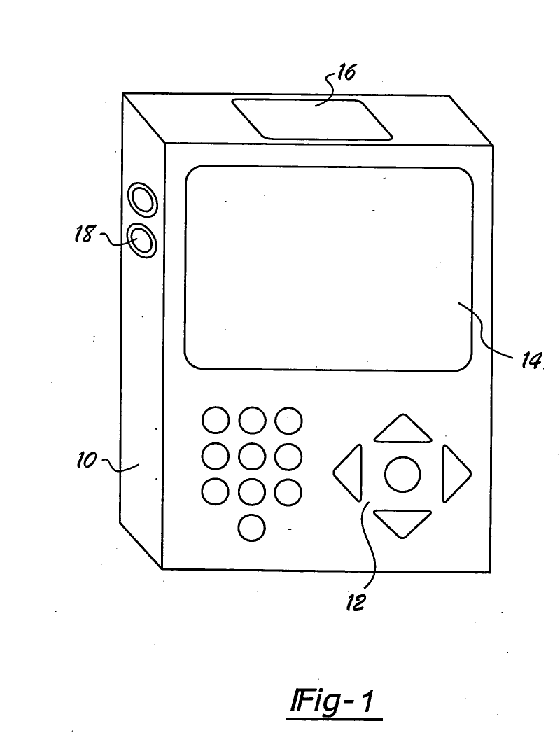

With reference to FIG. 1, one embodiment of a handheld control device operable to implement the present invention is illustrated. The control device generally includes a housing assembly 10, a user interface 12, and a display screen 14. A user interacts with the control device by way of the user interface 12. The user interface 12 may include a keyboard or keypad, functional buttons or switches, a touchscreen, or any combination thereof. The user interface 12 may provide means for manipulating applications and data on the control device itself, as well as conventional interaction with electronic devices such as televisions, video cassette recorders (VCRs), digital video disk (DVD) players, and other home appliances. In addition, a user may interact with the control device by direct contact with touch elements on the display screen 14 using, for example, a stylus pen. The handheld control device also includes a communication means 18 for transmitting and receiving wireless data.

In one embodiment, the handheld control device is a personal data assistant (PDA).

In another embodiment, the handheld control device includes a PDA stylus pen for handwriting input.

In another embodiment, the handheld control device includes additional communications means 18 for uploading and downloading data to and from a personal computer.

In yet another embodiment, the handheld control device includes additional communication means for transmitting and receiving wireless data, including, but not limited to, wireless Internet data.

In yet another embodiment, the handheld control device includes external peripherals such as a secure digital (SD) memory card for storing additional data.

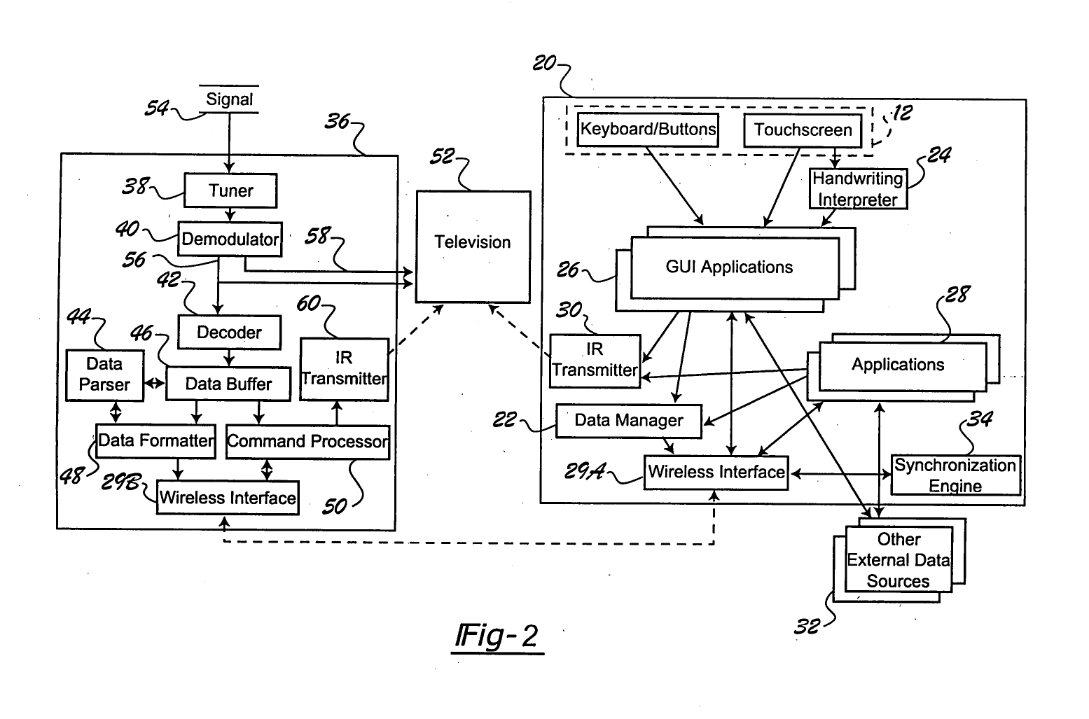

With reference to FIG. 2, one embodiment of the system architecture is described. The handheld device 20 comprises a data manager 22 incorporating the aforementioned data parser and metadata database, and a data request command processor; a synchronization engine 34; a handwriting interpreter 24; the graphical user interface (GUI) applications 26 and any other necessary applications 28; the aforementioned user interface 12; and a wireless interface 29A (such as IEEE 802.11b or Bluetooth interface). The handheld device may also incorporate one or more IR interfaces 30.

The data manager 22 incorporates a metadata database that stores the data downloaded from the television set-top box (STB) 36. Storing the data locally on the handheld device allows a user to quickly retrieve information. This information can then be presented to the user through a GUI application 26 on the handheld device. Because the data is stored locally, the user can view the information at any time, whether a television is present or not. The data is stored on the handheld device in a convenient format, such as extensible markup language (XML), to ease the transition between the device and various contents from service providers. The data parser interprets the downloaded data to be transmitted to the handheld device.

Using the system architecture as described in FIG. 2, a data request processor is also included in the data manager 22 and is used to download data to the handheld device upon a user's demand. This functionality allows the handheld device to avoid the necessity of continuously polling the data from the STB 36, thereby conserving central processing unit (CPU) resources. Upon an input request from the user on a handheld device GUI application 26, data relating to the currently viewed program or commercial is downloaded to the handheld device. The data request processor receives the input requests from the user and relays the requests to the STB 36 through the wireless interface 29A and 29B. In addition, the user requests can be used to control the functions of an electronic device such as a television, VCR, or DVD player. In the present embodiment, the request message is in XML format, although it is to be understood that other message formats are possible. Also in the present embodiment, user datagram protocol (UDP), transmission control protocol (TCP), and/or Internet protocol (IP) is used for sending the request messages, although it is to be understood that other communication protocols are possible.

Continuing the reference to FIG. 2, the handheld device may also include a handwriting interpreter 24. The interpreter 24 receives handwriting requests from the user and integrates handwriting recognition and searching functions to optimize existing technologies to enhance information browsing and searching with the present invention. In one embodiment, a small writing input area is provided on the display screen for a user to input handwriting with the stylus pen. In another embodiment, the writing input area is provided in another location on the handheld device.

In one embodiment of the handwriting interpreter 24, a user can request specific channel control functions or channel information by writing the channel's mnemonic in the appropriate area. This mnemonic can be a default designation for the channel recognized by the handheld device, or a name assigned by the user. In the event that the user's handwritten request is not accurately recognized by the search engine, the GUI application 26 may provide a list of potential channels so that the user can select the correct channel.

The GUI applications 26 on the handheld device provide most of the interaction to the user. The GUI applications 26 present the data to the user for viewing and manipulation. Using the GUI applications 26, the user can request such information as electronic program guides (EPG's), supplementary program information, advertisement or product information, news highlights, or sporting event scores and statistics. In addition, the GUI applications 26 may provide the user with games related to currently viewed content, such as trivia, coupon opportunities, and the ability to play along with game shows. It is also to be understood that the GUI applications 26 or other resident applications 28 may communicate with other external data sources 32 such as household appliances, telephones, or other home electronics.

The handheld device may also implement a synchronization (sync) engine 34. The sync engine 34 synchronizes data with content downloaded from the Internet or other sources (such as SD Card, Compact Flash, and similar sources). This functionality allows the user to receive real-time supplementary program lists and information related to the currently-viewed programs. One embodiment allows the user to request information about an advertised product, request coupons for a product, or purchase a product online. Another embodiment allows the user to request more detailed information about a program that is not otherwise available in the data downloaded from broadcasting channels.

Still in reference to FIG. 2, the handheld device communicates with the STB 36 through wireless interface 29A and 29B. In the preferred embodiment, this wireless communication uses either IEEE 802.11b or Bluetooth interface protocol. However, it is to be understood that other protocols for implementing the wireless communication are possible. Both the handheld device 20 and STB 36 comprise a communication interface 29A and 29B applicable to the chosen wireless protocol.

The STB 36 comprises a television signal tuner 38, a demodulator 40, a metadata decoder 42, an STB data parser 44, a data buffer 46, a data formatter 48, and a user command processor 50. The STB unit 36 decodes and caches data. The STB 36 may be a unit separate from the television 52, as shown in FIG. 2, or it may be integrated within the television 52.

The broadcast television signal 54 is routed through a tuner 38 and a demodulator 40, then routed to both the television 52 and the STB's decoder 42. The decoder 42 is a hardware device that is able to receive a broadcast signal and to decode data transmitted in that signal, for example VBI decoder in analog broadcast, or a section filtering in digital broadcast.

Data is only sent during certain time intervals, and therefore cannot be instantly available upon a user's request. An STB data buffer 46 may therefore be implemented and used in conjunction with the decoder 42 to continuously collect data to store in the data buffer 46, which is time-stamped and channel-stamped. The presence of the STB parser 44 allows the user to retrieve data instantly from the data buffer 46. When the STB 36 receives a request from the handheld device 20 pertaining to a specific channel and time, the data buffer 46 will already contain the desired data. Using this method, data is available immediately upon request, allowing the user to receive apparently real-time responses. In another embodiment, data is transmitted continuously from the decoder 42 to the handheld device 20 rather than residing on an external buffer, and is available to the user upon request.

It is to be understood that the data buffer 46 may be able to store different classes of data for different durations. The buffer 46 may store EPG data indefinitely, but store distinct program or program content data for a limited duration. Storage durations may be fixed or customizable by the user. In one embodiment, EPG or program data is stored indefinitely until purged by the user. In another embodiment, EPG data is purged upon receipt of a predetermined trigger (such as expiration of a time limit or a power shutdown). Program data storage may be implemented in a similar manner, or implement additional features. In one embodiment, program data is purged from the buffer 46 upon the termination of the program. In another embodiment, program data is purged when the user tunes into a different broadcast channel. It is to be understood that many embodiments of the data buffer behavior are possible, and the invention is not limited to those embodiments disclosed above.

Before being transmitted through the wireless interface 29A and 29B (for example, Bluetooth or IEEE 802.11b) to the handheld device 20, the data may be routed through a data formatter 48. The data formatter 48 reformats the data to be compatible with different forms of media, then transmits the results. The data formatter 48 allows the handheld device to make use of a broader range of media formats.

A user command processor 50 processes the commands and requests from the handheld device 20. The command processor 50 receives the commands from the wireless interface 29A and 29B. When the processor 50 receives a command requesting data, the correct data is retrieved from the data buffer 46 and transmitted back to the handheld device 20 through the wireless interface 29A and 29B. When the processor 50 receives a command for controlling the television, VCR, or DVD player, appropriate commands are sent to the infra-red (IR) transmitter 60.

The IR transmitter 60 allows the handheld device to control the functions of televisions, VCR's, DVD players, and other appliances. The IR transmitter 60 is located in a position that allows it to communicate efficiently with any desired electronic devices. The implementation of the IR transmitter 60 allows a user, as well as the applications, to send commands and requests to electronic devices from anywhere within the limits of the wireless interface 29A and 29B (Bluetooth or IEEE 802.11b), rather than the relatively inadequate limitations of IR transmissions.

It should be readily understood that data can be received from analog or digital broadcast channels. Further embodiments described below relate more specifically to analog broadcast and therefore VBI data handling, but one skilled in the art will recognize applicability to data handling in many instances.

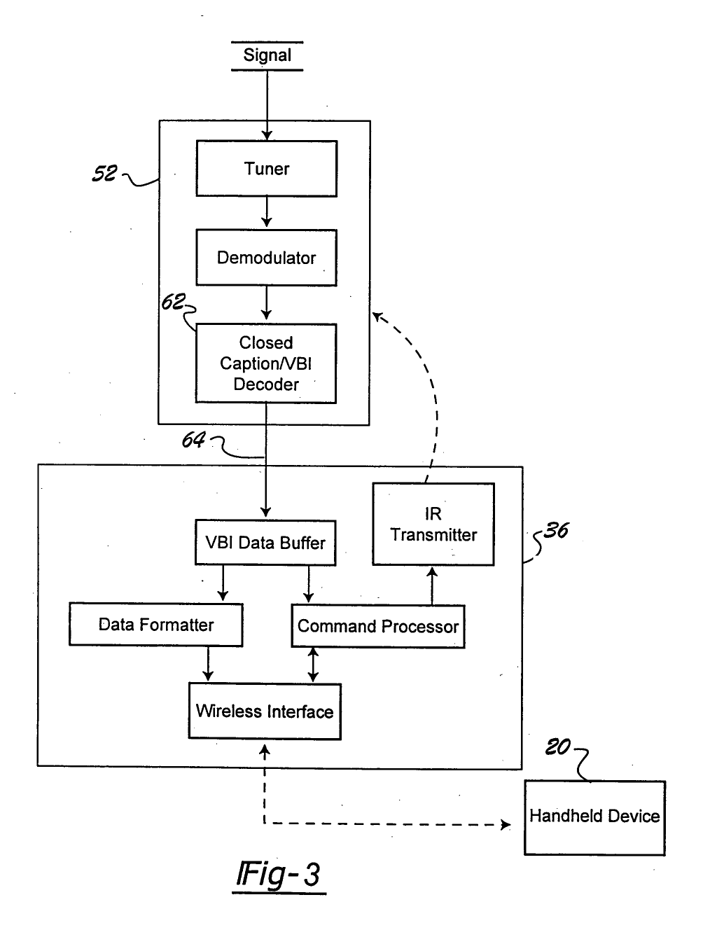

With reference to FIG. 3, another embodiment of the present invention is described. The existing closed caption (CC) device is enhanced to extract all VBI data to form an integrated CC/VBI decoder 62. This integrated decoder 62 is able to transmit the decoded CC/VBI data from the television 52 to an external device through a general purpose data port (GPDP) 64. FIG. 3 demonstrates this embodiment by describing the external device as an STB 36, but it is to be understood that other external devices are possible. In one embodiment, the integrated decoder 62 transmits the data directly to the handheld device 20 described in the present invention.

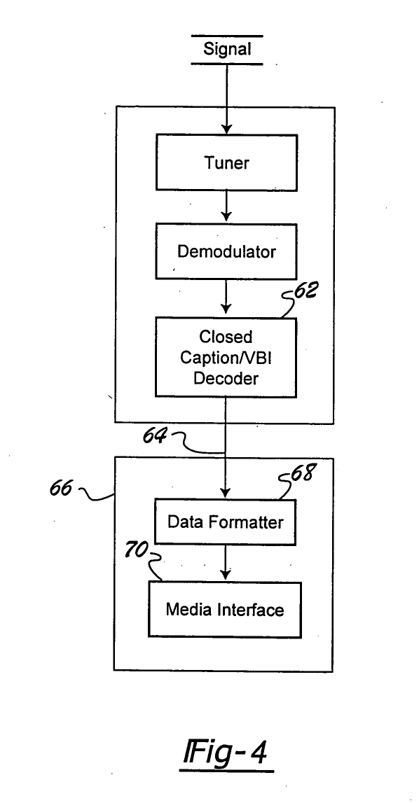

With reference to FIG. 4, another implementation of the integrated decoder 62 is described. The integrated decoder 62 transmits data through the GPDP 64 to one or more media bridges 66. The media bridge 66 comprises a data formatter 68 and a media interface 70. The data formatter 68 reformats the data stream received from the integrated decoder 62 to be compatible with the desired media interface 70. Once the data is reformatted to the desired media type, it is transmitted through the media interface 70 to the desired external device.

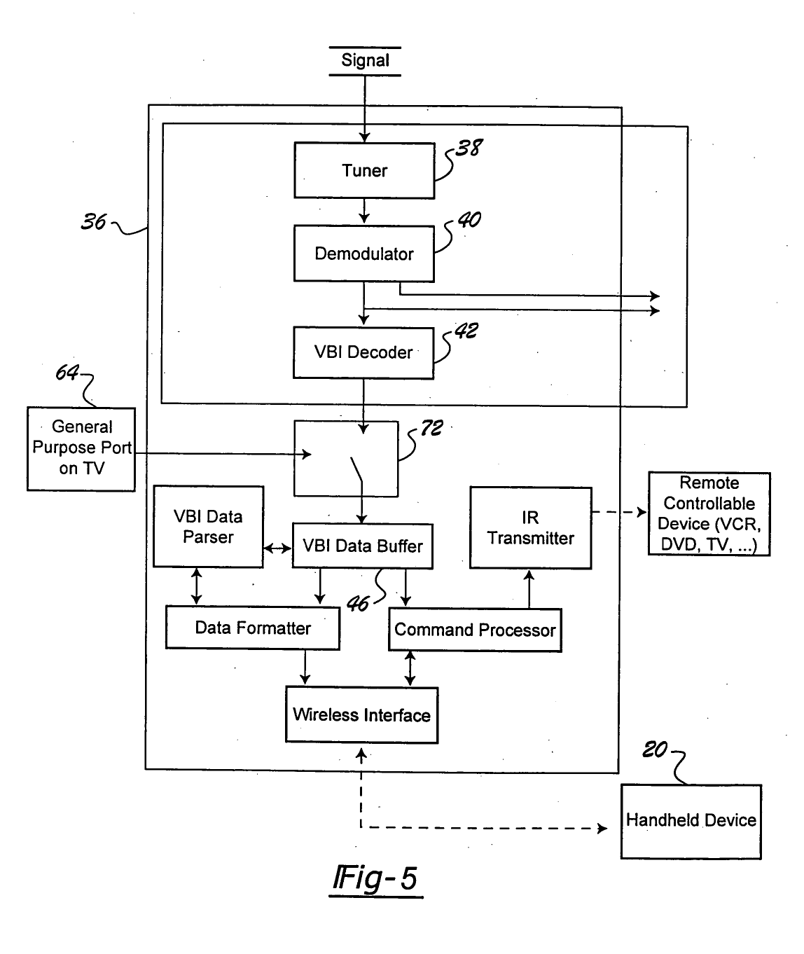

With reference to FIG. 5, an STB 36 incorporating the CC/VBI decoder is described. The STB 36 functions substantially as described in FIG. 2, although a switch 72 is incorporated. This switch 72 is able to receive data from either an integrated VBI decoder 42 or a GPDP 64 on a television or other external device. The GPDP 64 transmits data to the STB switch 72, which is able to route the data to the VBI data buffer 46. In one embodiment, the switch 72 is actuated by the user via a command on the handheld device 20. In another embodiment, the switch 72 is able to determine what type of data is being received and is actuated automatically depending on the content. The switch 72, in all embodiments, may be automatic or manual, and may be implemented using software, hardware, an external switch, or any combination thereof.

It is to be understood that the tuner 38, demodulator 40, and CC/VBI decoder 42 may either be permanently integrated with the STB 36 or be an optional removable plug-in card or module. In one embodiment, a plurality of modules may be used, with each separate module comprising separate components (such as a tuner, demodulator, GPDP interface, or decoder).

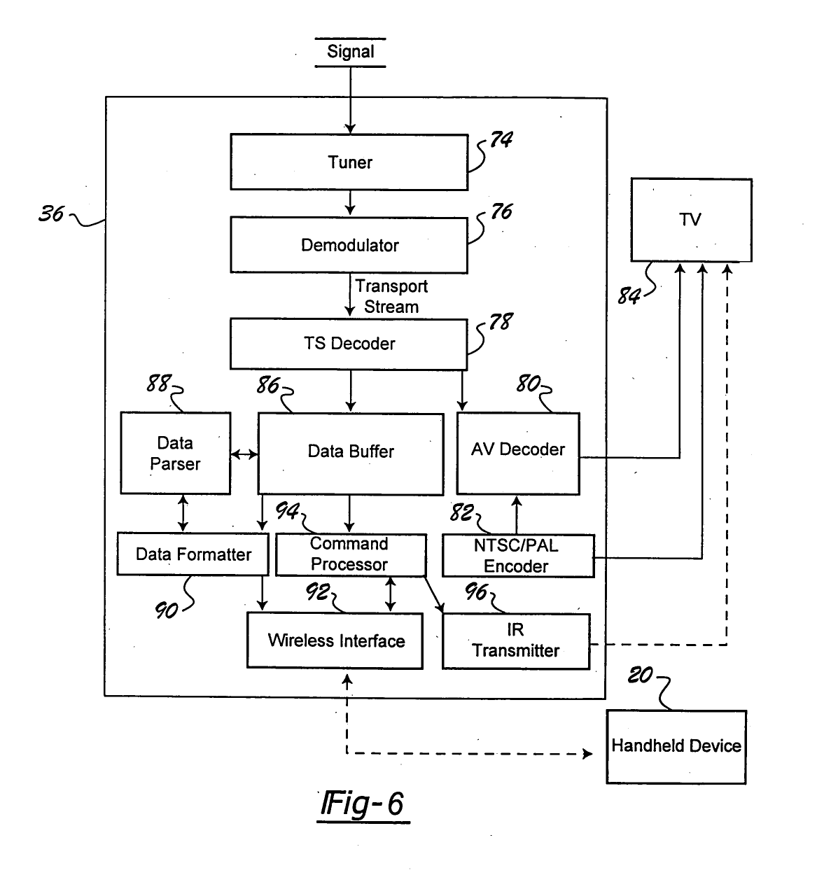

With reference to FIG. 6, STB 36 and hand-held device 20 may be operated according to a second embodiment as illustrated. The second embodiment is similar to the first embodiment illustrated in FIG. 2. However, the second embodiment deals with a digital broadcast signal particularly. The STB 36 includes a digital tuner 74, a demodulator 76 that outputs the transport stream (TS) from a digital broadcasting signal, and a TS decoder 78 that splits the transport stream into a data section and an A/V section. The data section from the transport stream may be cached in the data buffer 86. The A/V section from TS decoder 78 can be decoded with the use of an AV decoder 80. The digital A/V data from AV decoder 80 can be directed to a digital TV set 84 through a standard digital port such as digital visual interface (DVI) or high definition multimedia interface (HDMI). Alternatively, AV data from AV decoder 80 can also be encoded by NTSC/PAL encoder 82 and encoded analog signals sent to an analog TV.

The second embodiment also includes a data buffer 86, a data parser 88, a command processor 94, a data formatter 90, an IR transmitter 96, and a wireless interface 92. Once data is received in the data buffer 86, the process of manipulating data and transmitting data to the handheld device 20 is the same as in FIG. 2. The handheld device 20 of the second embodiment is the same as in the first embodiment.

It is to be understood that any functions described to be implemented on the handheld device may instead, or also (for redundancy), be implemented on a separate device. In one embodiment, the handheld device comprises a user interface, a wireless interface, and a display. All non-GUI applications, data management, and decoding capabilities reside on a separate device, such as the STB 36. In another embodiment, all non-GUI applications, data management, and decoding capabilities are integrated within the television, and the handheld device acts only as a means for displaying data to the user. In such a system, any functions of the STB 36 may also be integrated within the television. In still another embodiment, the handheld device comprises an Internet gateway, and all supplementary data related functions reside at a remote location. Many combinations of the allocation of functions within the system architecture are possible, and it is to be understood that the invention is not limited to those described above.

It is also to be understood that the present invention may utilize supplementary data other than, or in addition to, VBI data or transport stream data. One such alternative form of data is information which is embedded in the video signal itself, and therefore is transmitted concurrently with the video signal. Such methods of embedding supplementary data into the video signal are presently known in the art, as taught by Broughton et al. in U.S. Pat. No. 4,807,031, incorporated by reference herein. Another method for providing supplementary data is to transmit it concurrently on an alternative channel; methods such as this are also presently known in the art.

The description of the invention is merely exemplary in nature and, thus, variations that do not depart from the general substance of the invention are intended to be within the scope of the invention. Such variations are not to be regarded as a departure from the spirit and scope of the invention.

1. A television entertainment system having two-way communication capability with a hand-held remote device accessing an external information source, comprising:
a television receiver adapted to receive television programming content; and
a television set top box adapted to receive program related information over a broadcast channel and transmit the program related information to the hand-held remote device,
wherein the hand-held remote device is adapted to visually render information received over a broadcast channel and synchronize delivery of the program related information with delivery of related information from the external information source.

2. The system of claim 1, wherein said television set top box includes a vertical blanking interval data formatter adapted to reformat vertical blanking interval data to be compatible with different forms of media, thereby rendering hand-held remote device compatible with a broad range of media formats.

3. The system of claim 1, wherein said television set top box includes a command processor adapted to receive a command requesting vertical blanking interval data, retrieve requested data from a vertical blanking interval data buffer, and transmit the data to the hand-held remote device through a wireless interface, wherein the processor is further adapted to receive a command for controlling a remotely controllable device, and send appropriate commands to an infrared transmitter.

4. The system of claim 1, wherein said television set top box includes a tuner adapted to tune a specific channel of a television broadcast signal.

5. The system of claim 1, wherein said television set top box includes a demodulator adapted to demodulate a channel of a television broadcast signal.

6. The system of claim 1, wherein said television set top box includes a vertical blanking interval decoder adapted to receive a television channel and to decode vertical blanking interval data transmitted in that channel.

7. The system of claim 1, wherein said television set top box includes a vertical blanking interval parser adapted to continuously collect vertical blanking interval data and store it in a vertical blanking interval data buffer.

8. The system of claim 1, wherein said television set top box includes a pluggable tuner and decoder module.

9. The system of claim 1, wherein said television set top box includes a switch adapted to route vertical blanking interval data between a vertical blanking interval data buffer and a media device.

10. The system of claim 1, wherein said television set top box includes a media bridge having a data formatter and a media interface, wherein the data formatter reformats the data stream received from the integrated decoder to be compatible with the media interface, and once the data is reformatted to a predetermined media type, it is transmitted through the media interface to an external device.

11. The system of claim 1, wherein the hand-held remote device includes a vertical blanking interval buffer manager adapted to handle interaction between the hand-held remote device and a remotely controllable device.

12. The system of claim 11, wherein the buffer manager has a vertical blanking interval parser, has a vertical blanking interval buffer with time stamped and channel stamped contents, and is adapted to enforce a data purge policy removing data from the buffer based on at least one of:
(a) a fixed duration;
(b) a duration customizable by a user;
(c) a data purge command initiated by a user;
(d) a data purge initiated upon switch of channel;
(e) a data purge initiated upon termination of a television program; and
(f) a data purge initiated upon receipt of a trigger.

13. The system of claim 1, wherein said hand-held remote device includes a first input receptive of information from an external source, and a second input receptive of the program related information, and a user interface application receptive of user input, wherein the device is adapted to retrieve the programming information in response to a request from a user.

14. The system of claim 1, wherein said hand-held remote device includes a synchronization engine adapted to synchronizes vertical blanking interval data with content downloaded from the external information source, thereby permitting the user to receive real-time supplementary program lists and information related to the currently-viewed programs.

15. The system of claim 1, wherein said set-top box includes a digital tuner, a demodulator that outputs a transport stream from a digital broadcasting signal, and a transport stream decoder that splits the transport stream into a data section and an audio visual section.

16. The system of claim 15, wherein said set-top box includes a data buffer caching the transport stream.

17. The system of claim 15, wherein said set-top box includes an audio-visual decoder decoding the audio-visual section.

18. The system of claim 17, wherein said set-top box includes a digital port communicating the audio-visual section to a digital television.

19. The system of claim 17, wherein said set-top box includes a digital to analog encoder adapted to encode the audio-visual section and communicate the section to an analog television.

20. A method of delivering information to a television viewer via a hand-held device, comprising:
receiving programming information extracted from a television broadcast channel;
accessing additional information via an external information source;
identifying related information among the additional information based on the programming information; and
synchronously delivering the programming information and the related information to a user.

21. The method of claim 20, comprising receiving the television broadcast signal.

22. The method of claim 20, comprising extracting programming information from the channel of the television broadcast signal.

23. The method of claim 20, comprising communicating the programming information from a set top box to a hand-held device accessing the external information source.

24. The method of claim 20, comprising continuously decoding vertical blanking interval data and buffering the vertical blanking interval data as the programming information.

25. The method of claim 20, comprising formatting vertical blanking interval data to render it compatible with a broad range of types of additional data.

26. The method of claim 20, comprising routing vertical blanking interval data between a source of vertical blanking interval data and a media device.

27. The method of claim 20, comprising extracting a transport stream from a digital broadcasting signal.

28. The method of claim 27, comprising splitting the transport stream into a data section and an audio-visual section.

29. The method of claim 28, comprising caching the audio-visual section.

30. The method of claim 27, comprising decoding the audio visual section.
